(19) United States
(12) Patent Application Publication
(10) Pub. No.: US 2006/0010462 A1
(43) Pub. Date: Jan. 12, 2006

(54) Optical disc drive and optical disc cassette

(76) Inventor: Jui-Chiang Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,570

(22) Filed: Sep. 25, 2004

(30) Foreign Application Priority Data
Jul. 7, 2004 (TW) 93120306

(51) Int. Cl. G11B 17/03; G11B 17/04; G11B 33/02

(52) U.S. Cl. 720/614

(57) ABSTRACT

An optical disc cassette for accommodating optical discs is provided. The optical disc cassette comprises a housing, optical disc carriers and a cushioning pad. The housing has an inner wall, an opening and slide-track sets. The slide-track sets are disposed on the inner wall of the housing such that each slide-track set extends towards the opening of the housing. The optical disc carriers are disposed within the housing such that each optical disc carrier can slide along one of the slide-track sets. Each optical disc carrier has an indentation at an edge. The cushioning pad is disposed on the inner wall of the housing. Through the indentations, the optical discs on the optical disc carriers lean against the cushioning pad. Because the cushioning pads are disposed on the inner wall in a position to match the indentations on the optical disc carriers, the optical discs inside the cassette are stabilized.

### CROSS-REFERENCE TO RELATED APPLICATION

This application claims the priority benefit of Taiwan application serial no. 93120306, filed Jul. 07, 2004.

### BACKGROUND OF THE INVENTION

1. Field of the Invention

The present invention relates to an optical disc drive and an optical disc cassette. More particularly, the present invention relates to an optical disc drive and an optical disc cassette capable of holding a plurality of optical discs.

2. Description of the Related Art

An optical disc is among optical storage media that has many advantages including a high storage capacity, easy to produce and handle and a long and safe data storage period. No wonder the conventional magnetic storage media has been gradually replaced by optical discs in many applications. In the past, each optical disc drive can accommodate only one single optical disc. When a user needs to access another optical disc, discs have to be swapped manually. Due to the increasing demand for reading data from a stack of discs, a multi-disc drive capable of holding a plurality of optical discs simultaneously has been developed.

The aforementioned multi-disc drive typically has an optical disc cassette for holding multiple optical discs. Inside the optical disc cassette, each optical disc is held on a separate disc carrier. Because the optical discs are held in place on separate disc carriers that are all stacked close to each other, any vibration of the optical disc cassette and/or rotation of the discs may scratch the discs. The scratching not only damages the optical discs, but may also lead to the production of undesirable noise.

### SUMMARY OF THE INVENTION

Accordingly, the present invention is directed to provide an optical disc cassette for holding multiple optical discs firmly inside the cassette so that surface scratches resulting from rotation or vibration of the optical discs are minimized.

The present invention is directed to provide an optical disc drive having an optical disc cassette that can hold multiple optical discs firmly inside the cassette so that surface scratches resulting from rotation or vibration of the optical discs are minimized.

According to an embodiment of the present invention, an optical disc cassette for holding a plurality of optical discs is provided. The optical disc cassette comprises a housing, a plurality of optical disc carriers and a cushioning pad. The housing has an inner surface, an opening and a plurality of slide-track sets. The slide-track sets are disposed on the inner surface of the housing such that each slide-track set extends towards the opening of the housing. The optical disc carriers are disposed inside the housing such that each optical disc carrier can slide along one of the corresponding slide-track sets. Each optical disc carrier has an indentation at an edge. The cushioning pad is disposed on the inner surface of the housing. Through the indentations, the optical discs on the optical disc carriers lean against the cushioning pad.

According to an embodiment of the present invention, an optical disc drive comprising an optical disc cassette, a disc selecting mechanism and an optical disc data processing module is also provided. The optical disc cassette is designed for holding a plurality of optical discs. The optical disc data processing module is designed for reading data from the optical discs. And the disc selecting mechanism is designed to operate within a designated operation region for performing disc selection and the disc loading operation between the optical disc cassette and the optical disc data processing module. The optical disc cassette comprises a housing, a plurality of optical disc carriers and a cushioning pad. The housing has an inner surface, an opening and a plurality of slide-track sets. The slide-track sets are disposed on the inner surface of the housing such that each slide-track set extends towards the opening of the housing. The optical disc carriers are disposed inside the housing such that each optical disc carrier can slide along one of the corresponding slide-track sets. Each optical disc carrier has an indentation at an edge. The cushioning pad is disposed on the inner surface of the housing. Through the indentations, the optical discs on the optical disc carriers lean against the cushioning pad.

According to one embodiment of the present invention, the inner surface of the housing has an area facing the opening and the cushioning pad is disposed on the area facing the opening.

According to one embodiment of the present invention, the inner surface of the housing has a protruding portion and the cushioning pad is disposed on the protruding portion.

According to one embodiment of the present invention, the inner surface of the housing has a lead spring and the cushioning pad is disposed on the lead spring.

According to one embodiment of the present invention, the cushioning pad is fabricated from a shock-absorbing material, such as sponge or rubber.

According to one embodiment of the present invention, the optical disc cassette further comprises an engaging element disposed on the inner surface facing the opening. Furthermore, each optical disc carrier has an engaging portion designed to latch with the engaging element. The engaging element is a spring plate, for example.

According to one embodiment of the present invention, the optical disc processing module is an optical pick-up module or combining an optical pick-up module and an optical recording module, for example.

Accordingly, the cushioning pad is disposed on the inner surface of the optical disc cassette and each of the optical disc carriers has a corresponding indentation so that the optical discs on the optical disc carriers can be stabilized inside the optical disc cassette. Therefore, the optical discs are prevented from receiving damaging scratches as a result of direct hits between the optical discs and the optical disc carriers.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an optical disc drive according to one embodiment of the present invention.

FIG. 2A is a perspective view of an optical disc cassette according to one embodiment of the present invention.

FIG. 2B is a cutout view showing the internal structure of an optical disc cassette according to one embodiment of the present invention.

FIG. 3A is a perspective view showing the structure of an optical disc carrier according to one embodiment of the present invention.

FIG. 3B is a schematic cross-sectional view of an optical disc cassette according to one embodiment of the present invention.

FIG. 3C is a cutout view showing the structure of an optical disc loaded optical disc cassette according to one embodiment of the present invention.

FIG. 4 is a cutout view showing the structure of an optical disc loaded optical disc cassette according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

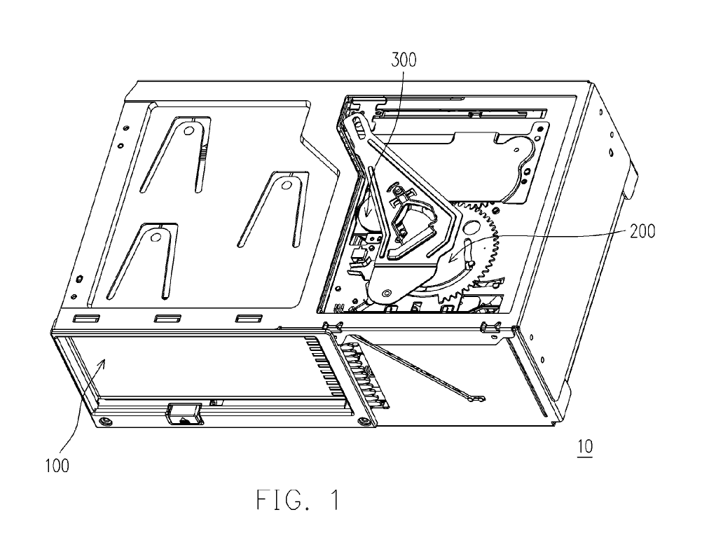

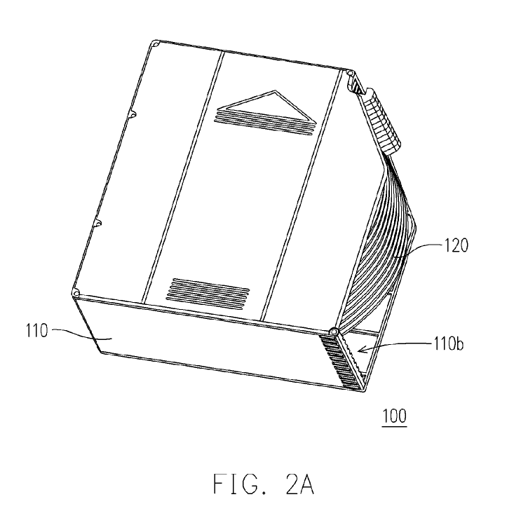

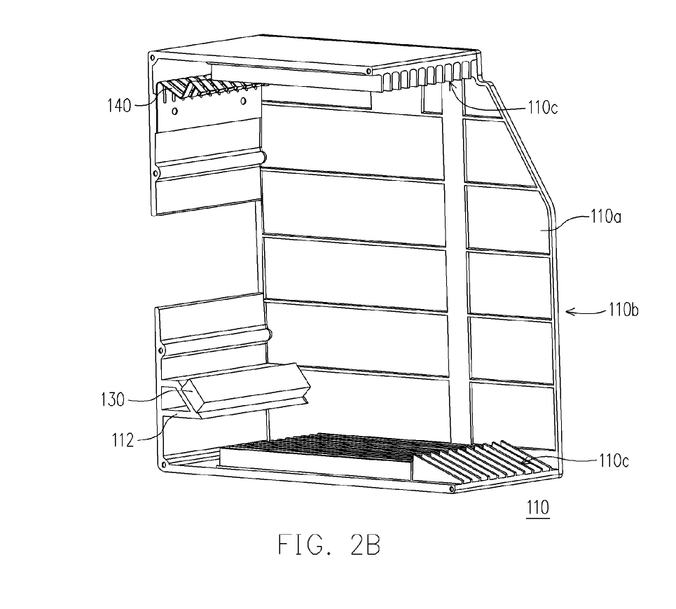

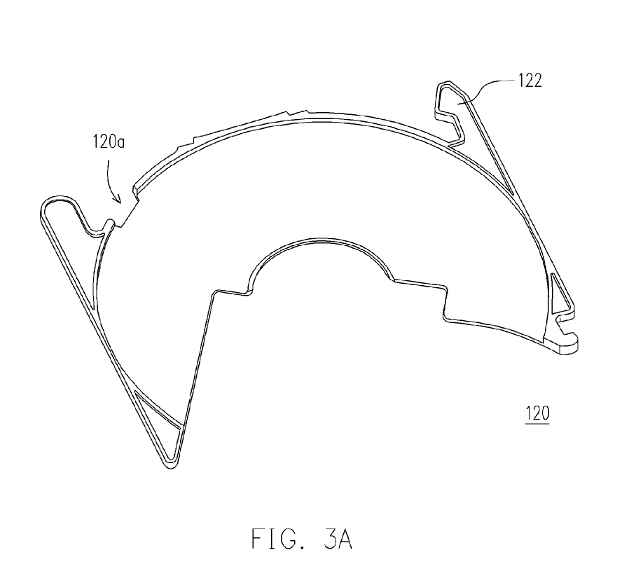

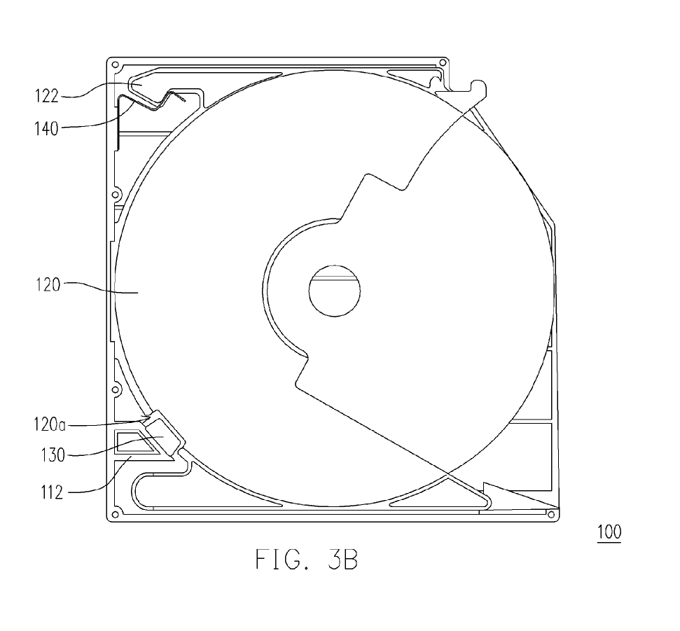

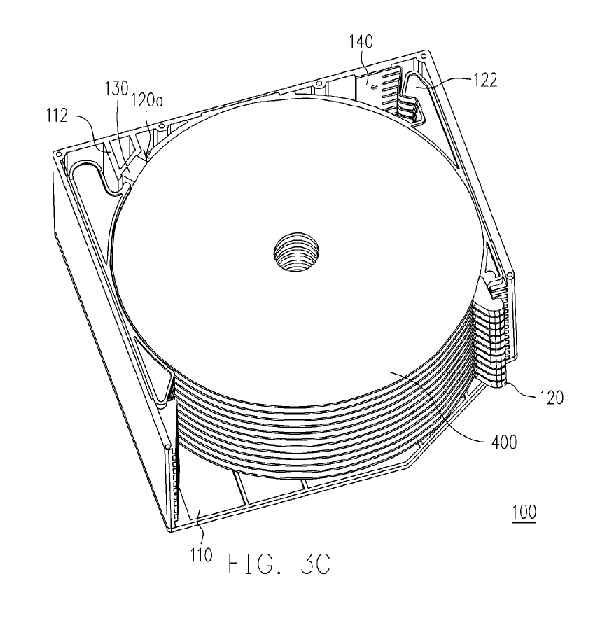

FIG. 1 is a perspective view of an optical disc drive according to one embodiment of the present invention. FIGS. 2A is a perspective view of an optical disc cassette according to one embodiment of the present invention. As shown in FIGS. 1 and 2A, the optical disc drive 10 can be a compact disc (CD) player, a laser optical (LD) video disc player, a video compact disc (VCD) player, a digital video disc (DVD) player or other type of optical disc drive capable of holding multiple optical discs at the same time. The optical disc drive 10 mainly comprises an optical disc cassette 100, a disc selecting mechanism 200 and an optical disc data processing module 300. The disc selecting mechanism 200 is designed to operate within a designated operation region. The optical disc data processing module 300 and the optical disc cassette 100 are both disposed within the operation region. The optical disc cassette 100 is designed to hold a plurality of optical discs 400 (as shown in FIG. 3C). The disc selecting mechanism 200 is designed to move an optical disc 400 from the optical disc cassette 100 into the optical disc data processing module 300 or return an optical disc 400 from the optical disc data processing module 300 back to the optical disc cassette 100. In addition, the disc selecting mechanism 200 is not limited to the design shown in FIG. 1. The disc selecting mechanism 200 can have a design using various combinations of levers and gears or other mechanical designs that facilitate the disc selection and the disc loading operation of optical discs 400.

The optical disc data processing module 300 is an optical pick-up module for reading data from the optical disc 400. However, the optical disc data processing module 300 can also have the capacity to write data into the optical disc 400, such as optical recording module. Since the optical disc cassette 100 has accommodated a number of optical discs, it should be noted that the user is able to select one of the optical discs 400 within the optical disc cassette 100 without switching discs manually which could be a time consuming and inconvenient step. The structure and function of the optical disc cassette 100 is explained in more detail in the following.

FIG. 2B is a cutout view showing the internal structure of an optical disc cassette according to one embodiment of the present invention. FIG. 3A is a perspective view showing the structure of an optical disc carrier according to one embodiment of the present invention. FIG. 3B is a schematic cross-sectional view of an optical disc cassette according to one embodiment of the present invention. FIG. 3C is a cutout view showing the structure of an optical disc loaded optical disc cassette according to one embodiment of the present invention.

As shown in FIGS. 2A and 2B, the optical disc cassette 100 mainly comprises a housing 110, a plurality of optical disc carriers 120 and a cushioning pad 130. The housing 110 has an inner surface 110a, an opening 110b and a plurality of slide-track sets 110c. The slide-track sets 110c are disposed on the inner surface 110a of the housing 110. The slide-track sets 110c extend in a direction toward the opening 110b of the housing 110. The optical disc carriers 120 are disposed inside the housing 110. Each optical disc carrier 120 is permitted to slide along one of the corresponding slide-track sets. Furthermore, the optical disc carriers 120 are free to slide into and out of the housing 110 through the opening 110b. The cushioning pad 130 is disposed on the inner surface 110a of the housing 110. In the present invention, the inner surface 110a has an area facing the opening 110b. The area has a protruding portion 112 and the cushioning pad 130 is set up on the protruding portion 112 as shown in FIG. 2B. The cushioning pad 130 is fabricated from a shock-absorbing material, such as sponge or rubber. In addition, the edge of each optical disc carrier 120 has an indentation 120a as shown in FIG. 3A and FIG. 3B.

When the optical disc carries 120 are installed inside the housing 110 with each optical disc carrier 120 holding an optical disc 400, the cushioning pad 130 is slightly sticking into the indentations 120a of the optical disc carriers 120. Through the indentations 120a, the optical discs 400 on the optical disc carriers 120 lean against the cushioning pad 130 as shown in FIG. 3C. It should be noted that the cushioning pad 130 disposed on the inner surface 110 is able to prevent the optical discs 400 from rotation or vibration and minimize scratching damages to the optical discs 400 when the optical discs 400 are enclosed within the optical disc cassette. Furthermore, because the optical discs 400 located inside the optical disc cassette 100 are supported by the cushioning pad 130, the optical discs 400 and the optical disc carrier 120 are prevented from colliding with each other through the vibrating or shaking of the optical disc cassette 100. Hence, noise emitted by the optical disc cassette 100 is minimized. Moreover, the cushioning pad 130 also stabilizes the optical disc carriers 120 inside the optical disc cassette 100 and lowers the noise created by the banging between the optical disc carriers 120 and the inner surface 110a of the housing 110.

As shown in FIGS. 3A through 3C, the cushioning pad 130 needs not be disposed on the protruding portion 112. The cushioning pad 130 can be disposed on a suitable position on the inner surface 110a when a matching indentation 120a on the optical disc carrier 120 is provided such that the cushioning pad 130 is able to contact the optical disc 400. In addition, to stabilize the optical disc carriers 120 assembled inside the housing 110, an engaging element 140 may be disposed on the inner surface 110a facing the opening 110b. Furthermore, the optical disc carriers 120 have a corresponding engaging portion 122. The engaging portion 122 of the optical disc carrier 120 and the engaging element 140 can be latched together through a spring plate as shown in FIG. 3B.

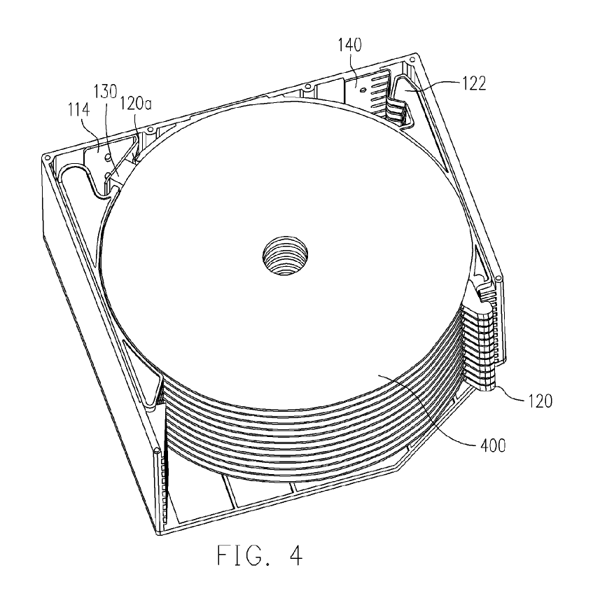

FIG. 4 is a cutout view showing the structure of an optical disc loaded optical disc cassette according to another embodiment of the present invention. As shown in FIG. 4, the protruding portion 112 can be replaced by a leaf spring and the cushioning pad 130 disposed thereon so that the cushioning pad 130 and the optical discs 400 are in tighter contact. The leaf spring provides an elastic preload force so that the cushioning pad 130 and the optical discs 400 are brought into closer contact with each other.

In summary, major advantages of the optical disc drive and optical disc cassette of the present invention includes:

1. The cushioning pad is disposed on the inner surface of the optical disc cassette and the optical disc carriers has a corresponding indentation so that the optical discs on the optical disc carriers can lean against the cushioning pad to prevent a collision between the discs and the carriers. Thus, damages to the optical discs due to collision are minimized. Moreover, the cushioning pad is able to stabilize the optical discs within the optical disc carriers as well as the optical disc carriers inside the optical disc cassette. Hence, the noise produced by the collision between the optical disc carrier and the optical disc or between the optical disc carrier and the optical disc cassette is significantly reduced.

2. When a rotating optical disc is returned to the optical disc cassette, the cushioning pad inside the optical disc cassette not only damps out the spinning disc, but also eases any vibration that might cause damages to the optical discs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc cassette for holding a plurality of optical discs, comprising:
a housing having an inner surface, an opening and a plurality of slide-track sets, wherein the slide-track sets are disposed on the inner surface and the slide-track sets extend in a direction towards the opening;
a plurality of optical disc carriers disposed inside the housing, wherein each optical disc carrier is free to slide along the slide-track sets and an edge of each optical disc carrier has an indention thereon; and
a cushioning pad disposed on the inner surface, wherein at least one of the optical discs within the respective optical disc carrier leans against the cushioning pad through the indentation.

2. The optical disc cassette of claim 1, wherein the inner surface has an area facing the opening and the cushioning pad is disposed on the area facing the opening.

3. The optical disc cassette of claim 2, wherein the inner surface has a protruding portion and the cushioning pad is disposed on the protruding portion.

4. The optical disc cassette of claim 2, wherein the inner surface has a leaf spring and the cushioning pad is disposed on the leaf spring.

5. The optical disc cassette of claim 1, wherein the cushioning pad is fabricated from a shock-absorbing material.

6. The optical disc cassette of claim 5, wherein the buffer material comprises sponge or rubber.

7. The optical disc cassette of claim 1, wherein the cassette further comprises an engaging element disposed on the inner surface and each optical disc carrier has an engaging portion for latching with the engaging element.

8. The optical disc cassette of claim 7, wherein the latching element comprises a spring plate.

9. An optical disc drive, comprising:
an optical disc cassette for holding a plurality of optical discs, wherein the optical disc cassette further comprising:
a housing having an inner surface, an opening and a plurality of slide-track sets, wherein the slide-track sets are disposed on the inner surface and the slide-track sets extend in a direction towards the opening;
a plurality of optical disc carriers disposed inside the housing, wherein each optical disc carrier is free to slide along the slide-track sets and an edge of each optical disc carrier has an indention thereon; and
a cushioning pad disposed on the inner surface, wherein at least one of the optical discs disposed within the respective optical disc carrier leans against the cushioning pad through the indentation;
an optical disc data processing module for reading data from the optical discs; and
a disc selecting mechanism for performing disc selection and the disc loading operation between the optical disc cassette and the optical disc data processing module.

10. The optical disc drive of claim 9, wherein the inner surface has an area facing the opening and the cushioning pad is disposed on the area facing the opening.

11. The optical disc drive of claim 10, wherein the inner surface has a protruding portion and the cushioning pad is disposed on the protruding portion.

12. The optical disc drive of claim 10, wherein the inner surface has a leaf spring and the cushioning pad is disposed on the leaf spring.

13. The optical disc drive of claim 9, wherein the cushioning pad is fabricated from a shock-absorbing material.

14. The optical disc drive of claim 13, wherein the buffer material comprises sponge or rubber.

15. The optical disc drive of claim 9, wherein the cassette further comprises an engaging element disposed on the inner surface and each optical disc carrier has an engaging portion for latching with the engaging element.

16. The optical disc drive of claim 15, wherein the latching element comprises a spring plate.

17. The optical disc drive of claim 9, wherein the optical disc data processing module comprises an optical disc pick-up module.

18. The optical disc drive of claim 17, wherein the optical disc data processing module further comprises an optical recording module.
